(19) United States
(12) Patent Application Publication
(10) Pub. No.: US 2004/0090177 A1
(43) Pub. Date: May 13, 2004

(54) Organic electroluminescent device and electrode substrate thereof

(76) Inventors: Yu-Kai Han, Taipei (TW); Hsia-Tsai Hsiao, Miaoli (TW)

Correspondence Address: BIRCH STEWART KOLASCH & BIRCH, PO BOX 747, FALLS CHURCH, VA, 22040-0747, US

(21) Appl. No.: 10/691,565

(22) Filed: Oct. 24, 2003

(30) Foreign Application Priority Data
Oct. 25, 2002 (TW) 091125341

(51) Int. Cl. H01J 1/62

(52) U.S. Cl. 313/504

(57) ABSTRACT

An electrode substrate for an organic electroluminescent device comprises a substrate, an electrode, and at least one buffer pad. In this case, the electrode is disposed on the substrate, and has a plurality of pixel areas. The buffer pad, which is made of nonconductive material, is disposed inside each of the pixel areas. A height difference between the buffer pad and the electrode is predetermined. Furthermore, an organic electroluminescent device, which comprises a substrate, a first electrode, a separating layer, at least one buffer pad, at least one organic functional layer, and a second electrode, is disclosed.

### BACKGROUND OF THE INVENTION

1. Field of Invention

The invention relates to an organic electroluminescent device and electrode substrate thereof. More particularly, the invention relates to an electrode substrate with a buffer pad, which can apply to an organic light-emitting diode, such as an OLED or a PLED.

2. Related Art

In all luminous materials, organic electroluminescent materials, which have been developed in recent years, are potential materials. The organic electroluminescent device including the organic electroluminescent material has the advantages of simple manufacturing process, simple structure, fast response speed, and low driving voltage, etc. More important, the organic electroluminescent device can use glass substrate, rigid substrate, plastic substrate, or flexible substrate. As a result, the organic electroluminescent device has a more broaden application scope in the optoelectronic products. Regarding to an organic electroluminescent device for displaying or illuminating, it can increase brightness and to enhance efficiency of electric-optic conversion. Recently, the organic electroluminescent device is developed towards energy-saving, power-saving and environmental protecting. The organic electroluminescent device can fulfill the mentioned requirements of energy-saving, power-saving, and environmental protecting.

The organic electroluminescent device uses the self-luminescence feature of organic functional materials to achieve the purpose of displaying.

In the manufacturing processes of full color organic electroluminescent devices, especially the polymer electroluminescent devices (PLEDs), ink-jet printing is one of the mainstream processes for forming the organic functional layer. There are many advantages of using the ink-jet printing process to form the organic functional layer. First, the ink-jet printing can use a single step to print the organic functional layer into any needed pattern, such as characters and irregular complicated patterns, without masks or printing screens. The complicated patterns broaden the application scopes of the organic electroluminescent device and decrease the time needed from design to production.

Second, in the ink-jet printing process, only the steps such as alignment, ink-jet printing, and crosslinking are needed, and the prior processes, such as exposure, development and cleaning, are unnecessary. Therefore, it doesn't have to use developers and strippers so as to decrease the environment protecting problems. Third, the equipments used in the ink-jet printing process are not many, the utility efficiency of materials is high, and the production cycle is short, resulting in decrease of the manufacturing cost.

Referring to FIG. 1, a conventional electrode substrate 3 of an organic electroluminescent device includes a transparent substrate 31, a transparent electrode 32, and a separating layer 33. During the ink-jet printing process, a printing head (not shown) ejects ink onto the transparent electrode 32 to form an organic functional layer (not shown).

However, during performing the ink-jet printing process to form the organic functional layer, the droplet ejected from the printing head has an accelerating speed. Thus, the speed of the droplet increases as long as the falling distance increasing. As a result, the droplet splashes when falling onto the transparent electrode. Moreover, the ink may overflow the pixel defined by the separating layer. This makes the organic functional layer with bad uniformity and decreases the yield of the process severely.

Therefore, it is an objective of the invention to provide an organic electroluminescent device and electrode substrate thereof that can solve the above-mentioned problems.

### SUMMARY OF THE INVENTION

In the view of the foregoing, an objective of the invention is to provide an organic electroluminescent device and electrode substrate thereof, which can decrease ink droplets overflowing, increase the uniformity of the organic functional layer and improve the production yield.

To achieve the above-mentioned objectives, the invention provides an electrode substrate for an organic electroluminescent device, which comprises a substrate, an electrode and at least one buffer pad. In the invention, the electrode is disposed on the substrate, and has a plurality of pixel areas. The buffer pad, which is made of nonconductive material, is disposed inside each of the pixel areas. A height difference between the buffer pad and the electrode is predetermined. Furthermore, the invention also discloses an organic electroluminescent device, which comprises a substrate, a first electrode (the previous-mentioned electrode), a separating layer, at least one buffer pad, at least one organic functional layer, and a second electrode.

As described above, the invention provides an organic electroluminescent device and electrode substrate thereof has a buffer pad disposed on the electrode or on the first electrode to decrease the cohesion force of the falling ink droplets. Comparing to the prior art, the invention has a buffer pad or buffer pads to decrease the falling droplet cohesion force and to lower the speed of the droplets when hitting the electrode or the first electrode, and then to reduce the droplets overflowing. Meanwhile, the buffer pad can increase the ink droplets uniformity and further improve the yield of productions.

### BRIEF DESCRIPTION OF THE DRAWINGS

The invention will become more fully understood from the detailed description given hereinbelow illustration only, and thus is not limitative of the present invention, and wherein:

FIG. 1 is a schematic view showing the conventional electrode substrate of the electroluminescent device;

FIG. 2A and FIG. 2B are schematic three-dimensional views showing an electrode substrate of an organic electroluminescent device according to an embodiment of the invention; and

FIG. 3 is a schematic cross-sectional view showing an organic electroluminescent device according to an embodiment of the invention.

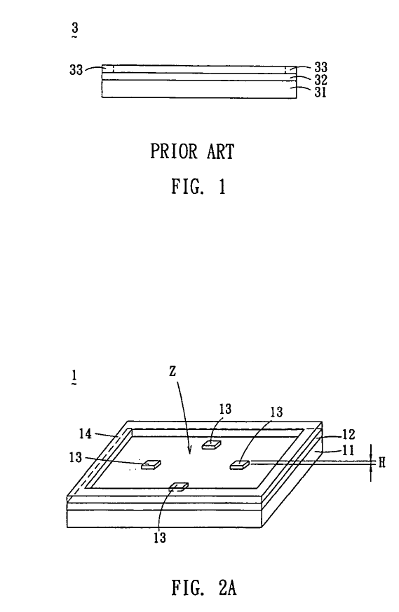

### DETAILED DESCRIPTION OF THE INVENTION

The present invention will be apparent from the following detailed description, which proceeds with reference to the accompanying drawings, wherein the same references relate to the same elements.

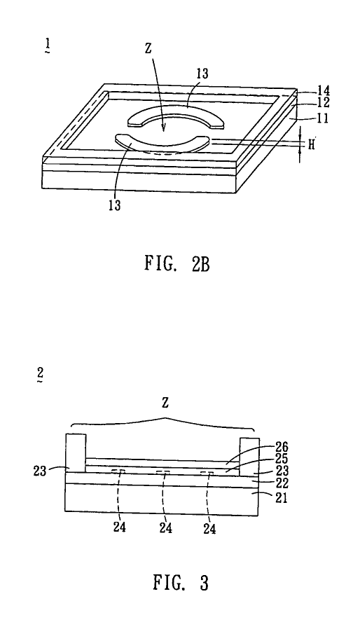

Referring to FIG. 2A and FIG. 2B, the invention provides an electrode substrate 1 of an organic electroluminescent device, which can be used in manufacturing an organic electroluminescent device, such as organic light-emitting device (OLED) and polymer light-emitting device (PLED). The electrode substrate 1 comprises a substrate 11, an electrode 12 and at least one buffer pad 13. In this embodiment, the electrode 12 is disposed on the substrate 11. As shown in the figures, the electrode 12 is disposed on the topside of the substrate 11, and has a plurality of pixel areas Z. The substrate 11 is a transparent substrate, and the electrode 12 is a transparent electrode.

The buffer pad 13 is made of nonconductive material, and is disposed on the electrode 12, wherein the electrode 12 is provided between the substrate 11 and the buffer pad 13. In the current embodiment, four buffer pads 13 are disposed inside each of the pixel areas Z and a height difference H between every buffer pad 13 and the electrode 12 is predetermined. As shown in the figures, the buffer pad 13 is higher than the electrode 12.

In the current embodiment, the transparent substrate 11 is a transparent substrate, which can be a glass substrate, a plastic substrate, or a flexible substrate. In particular, the flexible substrate or plastic substrate can be made of polycarbonate (PC), polyester (PET), cyclic olefin copolymer (COC), or metallocene-based cyclic olefin copolymer (mCOC).

The electrode 12 of the invention is disposed on the substrate 11 by way of a sputtering method or an ion plating method. A photolithography method is then performed to form a pattern of the electrode 12, as shown in FIG. 2A and FIG. 2B. Furthermore, the electrode 12 is a transparent electrode layer, which is made of a conductive metal oxide, such as indium-tin oxide (ITO), aluminum-zinc oxide (AZO), or indium-zinc oxide (IZO). The thickness of the electrode 12 is above 500 Å.

Referring to FIG. 2A and FIG. 2B, the buffer pad 13 is disposed on the transparent electrode 12 by sputtering or ion plating. The buffer pad 13 is a non-conductive material, which can be a photoresist, a polymer or a small molecular material. In this embodiment, the shape of the buffer pad 13 can be round, rectangular, or any size of irregular shape. The electrode substrate 1 may have one or more buffer pads 13. Alternatively, the electrode substrate 1 may have one layer of buffer pad 13. On the other hand, the total area of buffer pad 13 is less than 10% of the area of the total area of the pixel.

In this embodiment, the functions of the buffer pad 13 are to decrease the speed of the droplets fallen into the pixel areas Z, to decrease the cohesion force of the droplets, to improve the droplets uniformity, to reduce the droplets overflowing, and to increase the production yield.

With reference to FIG. 2A and FIG. 2B, the electrode substrate 1 of the organic electroluminescent device of this invention further comprises a separating layer 14, which is disposed on the electrode 12, and has a predetermined height to separate the pixels areas Z. In this embodiment, the buffer pad 13 is disposed inside the pixel areas Z. The separating layer 14 is made of a non-conductive material, such as photoresist, and is formed by way of an etching method or an ink-jet printing method.

Referring to FIG. 3, an organic electroluminescent device 2 according to a preferred embodiment of the invention comprises a substrate 21, a first electrode 22, a separating layer 23, at least one buffer pad 24, at least one organic functional layer 25, and a second electrode 26. In this case, the first electrode 22 is disposed on the substrate 21, such as the previous-mentioned electrode 12. The separating layer 23 is disposed on the first electrode 22 to define a plurality of pixel areas Z. The buffer pad 24 is disposed on the first electrode 22 and inside each of the pixel areas Z. The organic functional layer 25 is disposed on the pixels areas Z, and is sandwiched in between the first electrode 22 and the second electrode 26. The second electrode 26 is disposed over the first electrode 22, and on the organic function layer 25.

In this embodiment, the features and the functions of the substrate 21, the first electrode 22, the separating layer 23 and the buffer pad 24 are the same as the previously mentioned substrate 11, electrode 12, separating layer 14 and buffer pad 13, and will not repeat again.

In the current embodiment, the organic functional layer 25 can selectively comprises a hole injection layer, a hole transporting layer, an organic electroluminescent layer, an electron transporting layer, and an electron injection layer. The organic functional layer 25 is disposed on the buffer pad 24 by ink-inject printing method and has a thickness of 500 Å to 3000 Å. Furthermore, the organic functional layer 25 can emit blue light, green light, red light, white light or other monochromic light.

In addition, the second electrode 26 is often used as a metal electrode, cathode, and is disposed on the organic functional layer 25 by way of evaporation or sputtering. The material of the second electrode 26 can be aluminum, calcium, and magnesium-silver alloys. Of course, the material of the second electrode 26 can also be aluminum/lithium fluoride, or silver.

The invention is not limited to the above-mentioned embodiments. For example, the buffer pad can have a height less then the height of the electrode 12 or the first electrode 22. In such a case, the buffer pad still has the same function for buffering the ink droplets.

The organic electroluminescent device and electrode substrate thereof of the invention comprise a buffer layer inside the pixel areas to reduce the cohesion force of ink droplets in the ink-jet printing process. Comparing to the prior art, the invention decreases the cohesion force of the droplets before the droplets hit the electrode or the first electrode, lowers the speed of the fallen droplets, and reduce the droplets overflowing. Moreover, decreasing the cohesion force of the droplets improves the droplets uniformity and further raises the production yield.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An organic electroluminescent device, comprising:
a substrate;
a first electrode disposed on the substrate;
a second electrode disposed over the first electrode;
at least one organic functional layer sandwiched between the first electrode and the second electrode; and
at least one buffer pad, which is nonconductive and is disposed in a pixel area sandwiched between the first electrode and the second electrode, wherein a height difference between the buffer pad and the first electrode is predetermined.

2. The organic electroluminescent device of claim 1, further comprising:
a separating layer having predetermined height and disposed on the first electrode to separate the pixel areas.

3. The organic electroluminescent device of claim 2, wherein the separating layer is nonconductive.

4. The organic electroluminescent device of claim 1, wherein the buffer pad is formed by utilizing one method selected from the group consisting of sputtering method and ion plating method.

5. The organic electroluminescent device of claim 1, wherein the buffer pad is made of at least one selected from the group consisting of photoresist material, polymer material, and small molecular material.

6. The organic electroluminescent device of claim 1, wherein the total area of the buffer pad is less than 10% of that of the total area of the pixel.

7. The organic electroluminescent device of claim 1, wherein the substrate is at least one selected from the group consisting of glass substrate, plastic substrate, and flexible substrate.

8. The organic electroluminescent device of claim 1, wherein the first electrode is at least one selected from the group consisting of transparent conductive metal oxide electrode, indium-tin oxide (ITO) electrode, aluminum-zinc oxide (AZO) electrode, and indium-zinc oxide (IZO) electrode.

9. The organic electroluminescent device of claim 1, wherein the first electrode is formed by utilizing one method selected from the group consisting of sputtering method and ion plating method.

10. An electrode substrate for an organic electroluminescent device, comprising:
a substrate;
an electrode disposed on the substrate and has a plurality of pixel areas; and
at least one buffer pad, which is nonconductive and is disposed in the pixel areas, wherein a height difference between the buffer pad and the electrode is predetermined.

11. The electrode substrate of claim 10, further comprising:
a separating layer, which has a predetermined height and is disposed on the electrode to separate the pixel areas.

12. The electrode substrate of claim 11, wherein the separating layer is nonconductive.

13. The electrode substrate of claim 10, wherein the substrate is at least one selected from the group consisting of glass substrate, plastic substrate, and flexible substrate.

14. The electrode substrate of claim 10, wherein the electrode is at least one selected from the group consisting of transparent conductive metal oxide electrode, indium-tin oxide (ITO) electrode, aluminum-zinc oxide (AZO) electrode, and indium-zinc oxide (IZO) electrode.

15. The electrode substrate of claim 10, wherein the electrode is formed by utilizing one method selected from the group consisting of sputtering method and ion plating method.

16. The electrode substrate of claim 10, wherein the buffer pad is formed by utilizing one method selected from the group consisting of sputtering method and ion plating method.

17. The electrode substrate of claim 10, wherein the buffer pad is made of at least one selected from the group consisting of photoresist material, polymer material, and small molecular material.

18. The electrode substrate of claim 10, wherein the total area of the buffer pad is less than 10% of that of the total area of the pixel.
